(19) United States
(12) Patent Application Publication
(10) Pub. No.: US 2003/0174168 A1
(43) Pub. Date: Sep. 18, 2003

(54) Apparatus, method and computer program for providing a GUI representation of relationships between a set of resources of a data processing system

(75) Inventor: Phillip T. van Leersum, Shedfield (GB)

Correspondence Address: IBM Corp, IP Law, Zip 4054, 11400 Burnett Road, Austin, TX, 78758, US

(73) Assignee: International Business Machines Corporation

(21) Appl. No.: 10/285,998

(22) Filed: Oct. 31, 2002

(30) Foreign Application Priority Data
Mar. 16, 2002 (GB) 0206285.9

(51) Int. Cl. G09G 5/00

(52) U.S. Cl. 345/764; 345/853

(57) ABSTRACT

The invention relates to an apparatus, method and computer program for providing a GUI representation of relationships between a set of resources of a data processing system. This involves identifying a plurality of separable subsets each comprising one or more resources of the set of resources. At least one of said subsets comprises an hierarchically ordered plurality of resources. The separable subsets are represented as interconnected elements within a single GUI representation of the set of resources and the interconnections between elements represent relationships between the subsets of resources. An element corresponding to an hierarchically ordered plurality of resources includes a representation of the hierarchical order. Responsive to user interaction with one or more of the elements of the GUI representation, one or more elements are repositioned independently of the positioning of other elements of the GUI representation, and the representation of interconnections between the elements is updated in response to the repositioning to retain within the single GUI representation a representation of the relationships between the repositioned elements.

### FIELD OF THE INVENTION

The present invention relates to the representation of relationships between elements in a system.

### BACKGROUND OF THE INVENTION

It is frequently useful to be able to represent constituent parts of a system graphically in order to show the relationships that exist between those parts. Typically there is one prime relationship that can be used to group the parts into a hierarchy. This can be represented graphically as a tree (e.g. the left hand pane in the Microsoft® Windows® Explorer program (Microsoft and Windows are trademarks of Microsoft Corporation in the United States and/or other countries)). The tree representation however is not appropriate to show more than one relationship at a time between parts.

Parts in a complex system often have several kinds of relationship (or connection). More sophisticated representation of multiple relationships can be rendered using a ‘graph’ in which glyphs (graphic representations of constituent parts) (otherwise known as elements or nodes) are distributed across a two dimensional area, and the relationships are drawn as annotated lines. In this way it is possible to provide the user with more helpful information. Thus graphs are more useful than trees in, for example, system design/modelling.

Graphs can however, despite their advantages, rapidly become unmanageable as the number of glyphs/connections increases. Often such graphs are accompanied by a separate tree representation allowing the user to select some elements to display on the graph. The tree wastes valuable screen space. Any displayed element has two representations, one in the tree and one in the graph. This separates the hierarchy navigation tasks from the two dimensional arrangement tasks.

### DISCLOSURE OF THE INVENTION

Accordingly, the invention provides an apparatus for providing a GUI representation of relationships between a set of resources of a data processing system, including: means for identifying a plurality of separable subsets each comprising one or more resources of the set of resources, wherein at least one of said subsets comprises an hierarchically ordered plurality of resources; means for representing said separable subsets as interconnected elements within a single GUI representation of the set of resources, wherein the interconnections between elements represent relationships between the subsets of resources, and wherein an element corresponding to an hierarchically ordered plurality of resources includes a representation of the hierarchical order; and means, responsive to user interaction with one or more of said elements of the GUI representation, for repositioning said one or more elements independently of the positioning of other elements of said GUI representation, and updating the representation of interconnections between the elements in response to said repositioning to retain within the single GUI representation a representation of the relationships between the repositioned elements.

Thus it is possible to combine tree and graph representations within a single diagram, with a single element potentially including hierarchical information. This is different from U.S. Pat. No. 6,108,698 which discloses node-link data defining a graph and a tree within a graph. This patent discloses a means for converting a tree representation to a graph representation (and vice versa) in memory, but does not show both at the same time. There is further no means provided to allow manipulation of a structure by the user. This is also different from U.S. Pat. No. 5,515,487 which does not disclose means for representing separable subsets as interconnected elements within a single GUI representation of the set of resources. This is further different from WO 00/16307 which discloses a method and apparatus for visualising and exploring large hierarchical structures but which does not disclose a way of mixing tree and graph representations within the single diagram.

In a preferred embodiment it is possible to collapse, in response to user interaction, an element to a graphical node representation without collapsing other elements. Preferably the graphical node representation does not display that element's resources and all that is shown is a single node identifier (e.g. with an element including hierarchically ordered resources, only the root resource may be displayed as the result of a collapse action)

In a preferred embodiment, responsive to user interaction, it is also possible to collapse a hierarchically ordered resource, represented as part of an element, to hide any descendents also represented as part of that element, wherein the collapsing is performed without collapsing any part of another element.

The ability to independently collapse elements and parts thereof is extremely advantageous. A user may not be interested in all the detail of a particular element and collapsing it down to a graphical node representation/collapsing a hierarchically ordered resource to hide its descendents leaves more space to display the interesting information. Further, in collapsing an element, other elements are left alone, even those other elements which are descendents of an element being collapsed and which would therefore have in the past been hidden as a result of such a collapse action.

In one embodiment, it is possible to classify an element or part thereof as invisible such that they are not displayed to the user. This again can be done independently of other elements and enables screen-space to be saved, when a user is not interested in a particular element.

In a preferred embodiment, it is possible to extract (or detach) a subset of one or more resources from an existing hierarchically represented subset to create an element. Thus once again, interesting resources may be extracted and uninteresting detail can be collapsed from view/classed invisible. Further the extraction of elements enables hierarchical information to be retained whilst providing for the possibility of showing other relationships between resources by incorporating ordinary graph concepts.

In order to extract a subset, information is stored regarding which resources should be extracted as part of the subset and further information is stored for retaining a representation of relationships between the resources in the subset, within the GUI representation, when the element is created. In one embodiment, all resources have hierarchical order and they are referenced via one large structure. When a resource and any children are extracted as a subset that resource is marked as detached. This is so that if the parent of this resource is extracted, all descendents that are not marked as detached can also be extracted. Once a detached descendent is found, it and its descendents are left along—see later.

Preferably it is also possible to reattach an extracted subset to the hierarchically represented subset from which it was extracted. Whether the extracted subset is displayed (in its currently displayed form) when reattached preferably depends on whether the part of the hierarchy to which the extracted subset is reattached, is collapsed. If it is collapsed, then the reattached subset is not displayed/represented, otherwise it is.

In the preferred embodiment, means is provided for resizing an element to take account of a change made to an element. For example, when a subset is extracted, the element from which it is extracted is made smaller and likewise the opposite is true if a subset is reattached. This automatic resizing means that screen space is not wasted unnecessarily.

Preferably it is possible to define at least one rule regarding the behaviour (including, for e.g., display) of an element. For example a rule ensuring that children of the same parent should be displayed in the same colour as each other. This makes it easier to determine the parent of an extracted subset (see later for a more detailed explanation). Information may be displayed on a status bar to identify a detached glyph's parent, grand-parent etc. Another rule may define that a node is non-detachable and that this node should be displayed in the same colour as its parent to indicate this.

In a preferred embodiment, it is also possible to define at least one rule regarding the display of a relationship between two elements. For example a relationship should not be displayed if the source or destination node is attached.

Preferably it is possible to associate a definition with at least some resources. It is then possible to determine that a relationship should be displayed between two elements (each element comprising at least one hierarchically ordered resource) based on the definition associated with the root resource of each element. For example, resources of type queue use resources of type connection and a link should be drawn between a particular queue and connection if they have some part in common (e.g. name part—see later).

Preferably it is also possible to automatically annotate the relationship between two elements, each element comprising at least one hierarchically ordered resource. The annotation is preferably based upon a definition associated with the root resource of each element.

According to another aspect, the invention provides a method for providing a GUI representation of relationships between a set of resources of a data processing system, including: identifying a plurality of separable subsets each comprising one or more resources of the set of resources, wherein at least one of said subsets comprises an hierarchically ordered plurality of resources; representing said separable subsets as interconnected elements within a single GUI representation of the set of resources, wherein the interconnections between elements represent relationships between the subsets of resources, and wherein an element corresponding to an hierarchically ordered plurality of resources includes a representation of the hierarchical order; and responsive to user interaction with one or more of said elements of the GUI representation, repositioning said one or more elements independently of the positioning of other elements of said GUI representation, and updating the representation of interconnections between the elements in response to said repositioning to retain within the single GUI representation a representation of the relationships between the repositioned elements.

In one embodiment, it is also possible to display the hierarchical relationship between a resource and its ascendants. This could be for example when that resource is selected or when the mouse pointer hovers over that resource. The hierarchical relationship displayed is useful as it indicates a resource's parent, even when that resource is part of an extracted element (e.g. is not displayed as part of its parent—see later).

According to yet another aspect, the invention provides a computer program for providing a GUI representation of relationships between a set of resources of a data processing system, said program comprising program code means adapted to perform the following steps: identifying a plurality of separable subsets each comprising one or more resources of the set of resources, wherein at least one of said subsets comprises an hierarchically ordered plurality of resources; representing said separable subsets as interconnected elements within a single GUI representation of the set of resources, wherein the interconnections between elements represent relationships between the subsets of resources, and wherein an element corresponding to an hierarchically ordered plurality of resources includes a representation of the hierarchical order; and responsive to user interaction with one or more of said elements of the GUI representation, repositioning said one or more elements independently of the positioning of other elements of said GUI representation, and updating the representation of interconnections between the elements in response to said repositioning to retain within the single GUI representation a representation of the relationships between the repositioned elements.

### BRIEF DESCRIPTION OF THE DRAWINGS

A preferred embodiment of the present invention will now be described, by way of example only, and with reference to the following drawings:

FIG. 1 shows a hierarchical representation of elements in a system in accordance with a preferred embodiment of the present invention;

FIGS. 2, 3, 11 and 12 show how the hierarchical representation of FIG. 1 can be manipulated in accordance with a preferred embodiment of the present invention; and

FIGS. 4 to 10 illustrate the processing involved to achieve the functionality of the present invention in accordance with a preferred embodiment.

### DESCRIPTION OF THE PREFERRED EMBODIMENTS

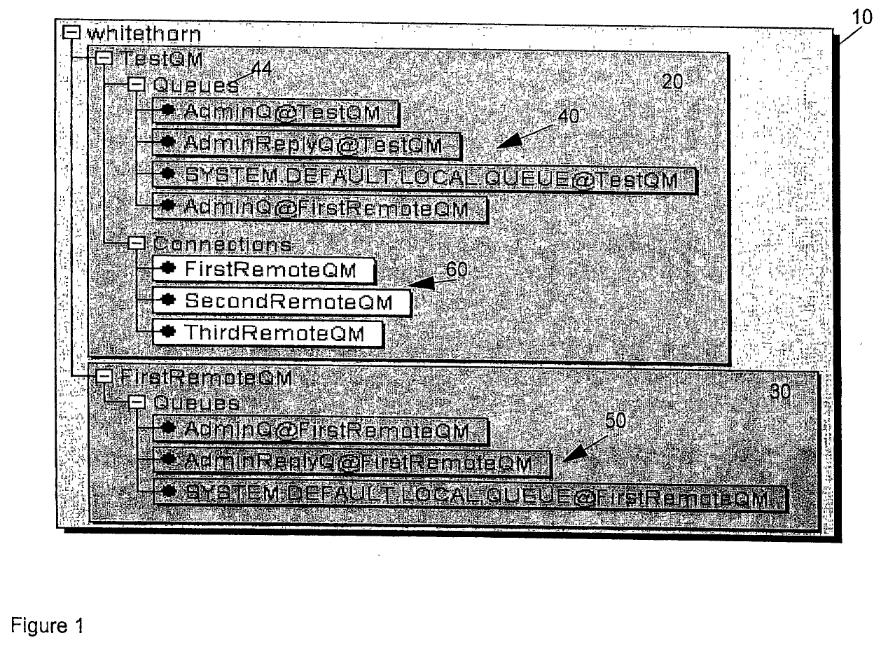

FIG. 1 shows a typical hierarchical or tree structure representing the components of a system “whitethorn” graphically. A single tree of objects is illustrated, with these objects being expandable and collapsible via the use of ‘+’ and ‘−’ symbols as is common practice.

It can be seen from the figure that a host system whitethorn 10 is running two queue managers, TestQM 20 and FirstRemoteQM 30, each queue manager having a relationship with a number of queues 40, 50. The TestQM 20 additionally has a relationship with the listed connections 60 which make reference to other queue managers.

It will therefore be appreciated that the representation of information pertaining to such relationships is very limited using this tree-like graphical form. It is possible to determine that a relationship exists without really understanding what form such a relationship takes. It is thus much more difficult to use such a form effectively in, for example, modelling a system.

The present invention, however, enables tree and graph representations to be used in conjunction with one another in a single diagram and thus permits greater flexibility and control of diagram complexity. A user is therefore able to create new glyphs, which may be classed as parent glyphs (e.g. 10) or children of a parent glyph (e.g. 20), and is then able to create more meaningful associations between such glyphs.

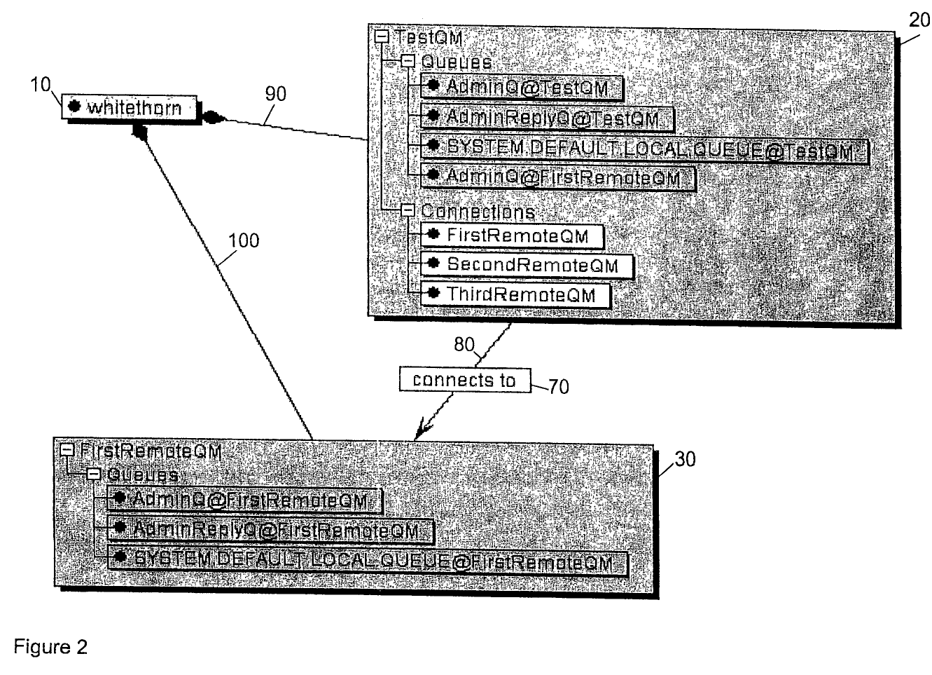

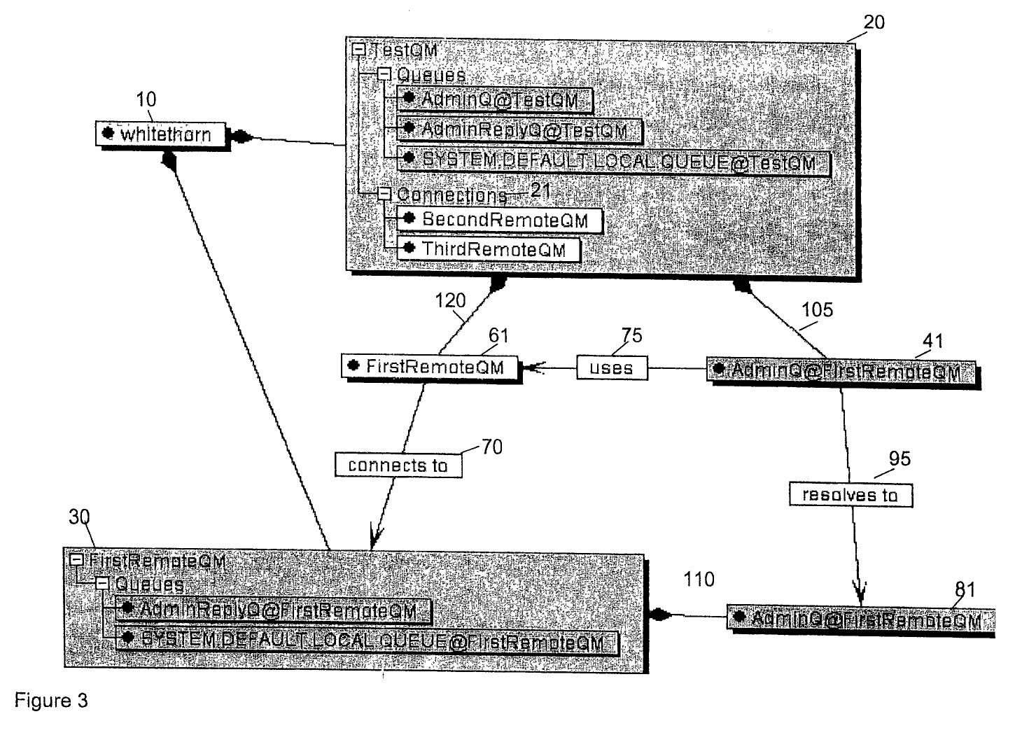

FIG. 2 shows a graphical display in accordance with a preferred embodiment of the present invention. In order to better visualise the relationships between system components, a user is able to separate out the glyphs whitethorn 10; TestQM 20; and FirstRemoteQM 30 using a drag-and-drop interface. Additionally edges (or connectors) 80 can be used to illustrate the relationship between glyphs such as the two queue managers. Such edges can be given labels 70 (annotated) to make these relationships visually more meaningful. Special edges (connectors) 90, 100 are used to indicate to the user that the connected glyph 20, 30 has been separated from its logical parent (i.e. the highest attached parent of the real parent)—see the description with reference to FIG. 3 for a more detailed explanation.

In this embodiment the symbol which defines aggregation in the Unified Modelling Language, or UML, is used since this will already be familiar to many users. This symbol consists of a line with a diamond at the end. The glyph nearest the diamond is the logical parent of the glyph at the other end. Of course in some environments, such a symbol may be deemed inappropriate. For example, if the chief hierarchical relationship is not one in which the child's existence is circumscribed by the parent's existence. To expand upon this, there is often one overriding set of relationships between entities that people find easiest to use as a ‘map’. They can then define any single entity in relation to a known starting point (‘root’) and a series of traversals. The most common relationship seems to be one of ownership. So a definition might be (Host)LocalHost—(QueueManager)TestQM—(Queue)LocalQueue—(QueueAlias)Alias. The use of ‘ownership’ or ‘containment’ seems the most natural to people (i.e. deletion of a parent, automatically results in the deletion of all contained children). In some cases it is conceivable that the most natural hierarchy is not one of ‘containment’. One such example might be family trees, where the natural hierarchy might be from parent to child but children are not (for most of their life) contained within their parents. So deleting a parent does not delete automatically delete the child. In other words parents may predecease their children.

It will of course be appreciated that in some diagrams no special edges will be required. For example, it may be necessary to illustrate two systems (one or both possibly including children), neither a child of another entity, which have some sort of relationship with each other. Colour coding or some other display characteristic may also be used to indicate which children belong to a parent glyph (e.g. brothers and sisters might be depicted in the same colour).

FIG. 3 shows how a user has continued to separate other components from their parent and to annotate the relationship between such components. (Note such annotation may be an automatic process—see later.) Thus it can be seen that the TestQM queue manager 20 is associated with a FirstRemote connection 61, which has been separated out from its parent (see special edge 120). Queue manager 20 uses connection 61 to connect to the FirstRemoteQM 30 (this is further indicated by the “connects to” label 70). It can further be seen that the AdminQ@FirstRemoteQM 41 was initially illustrated as part of the TestQM glyph 20 (see special edge 105) and this “resolves to” 95 AdminQ@FirstRemoteQM 81 which was initially part of the FirstRemoteQM glyph 30 (see special edge 110). Glyph 41 uses the FirstRemoteQM connection 61 to connect to the FirstRemoteQM queue manager 30 and this is indicated by “uses” label 75.

As mentioned above special edges are used to define an association with a logical parent which is the highest attached parent of the real parent. Thus in FIG. 3, glyph 61 has as its parent ‘connections’ 21 which is still attached to the TestQM queue manager 20 (in fact, in the preferred embodiment, glyphs with no border such as 21 are not detachable). It will therefore be appreciated that TestQM 20 is the logical parent of glyph 61 and this is indicated to the user by special edge 120. If TestQM 20 were to be reattached to whitethorn 10, then whitethorn becomes the logical parent of 61. The idea of associating a separated glyph with its logical parent means that special edges are properly displayed to the user (e.g. lines are less likely to cross one another).

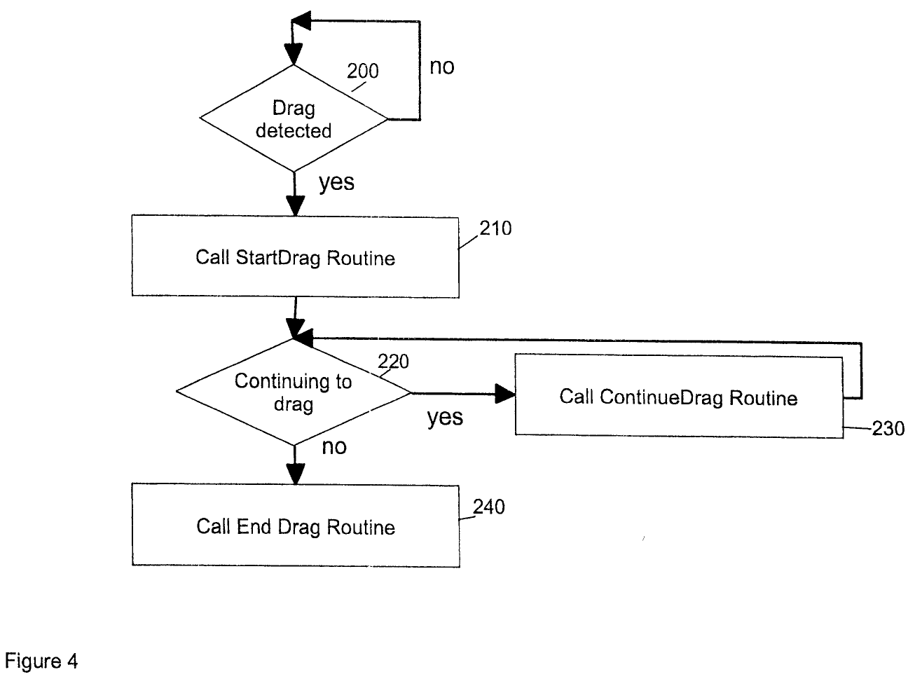

FIGS. 4 to 10 illustrate the processing involved to achieve the functionality of the preferred embodiment and will be referred to below.

First however, it should be noted that a user is able to create a hierarchical structure such as that indicated in FIG. 1, according to normal practice. A create parent glyph function is called to create a parent, and an add child function may then be called on that parent to associate a child therewith. What is new is the ability to separate children (and their descendents) out from their parents in order to enable more meaningful relationships between elements to be displayed. It should however be appreciated, that independent of whether a child node is displayed as part of its parent (i.e. it is attached) or it has been separated from its parent (i.e. it is detached), behind the scenes the information pertaining to a particular structure is still stored and accessed hierarchically.

FIG. 4 shows a mouse handling routine in accordance with a preferred embodiment of the present invention. At step 200 it is determined whether a mouse drag action has been detected. (Such an action is used to move a glyph to another position on the screen.) To explain this in more detail, there is a mouse controller monitoring mouse events, including mouseButtonDown; mouseMoved; mouseDragged; mouseButtonUp; and mouseButtonClicked. These are used to determine that a mouse drag action has occurred.

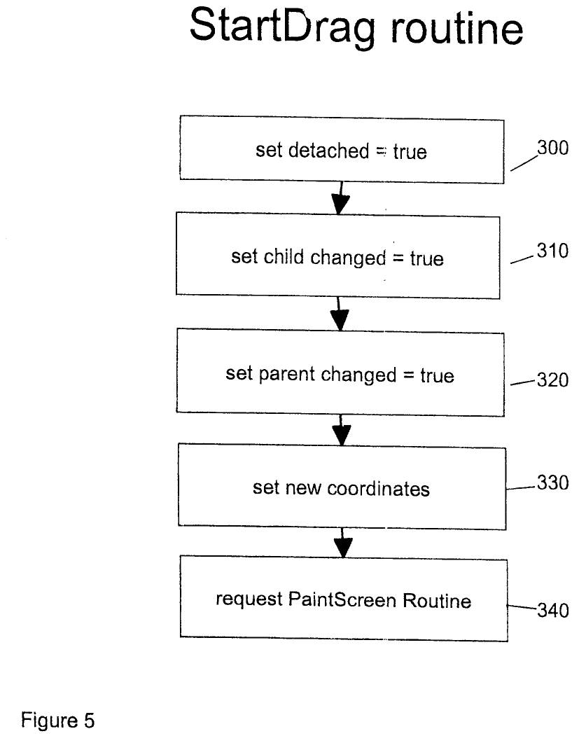

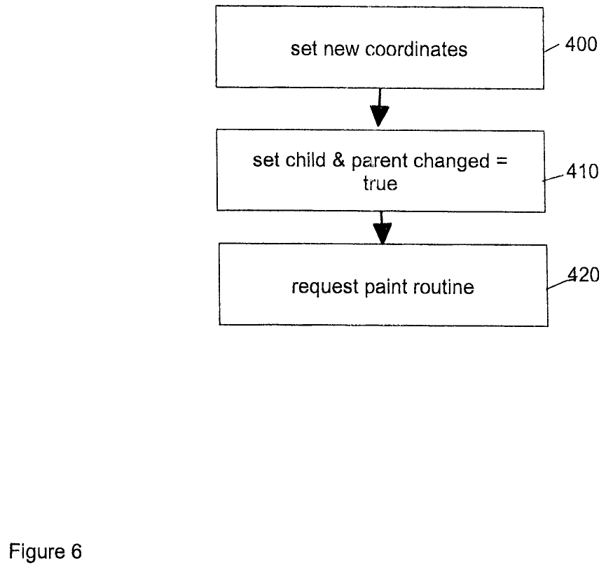

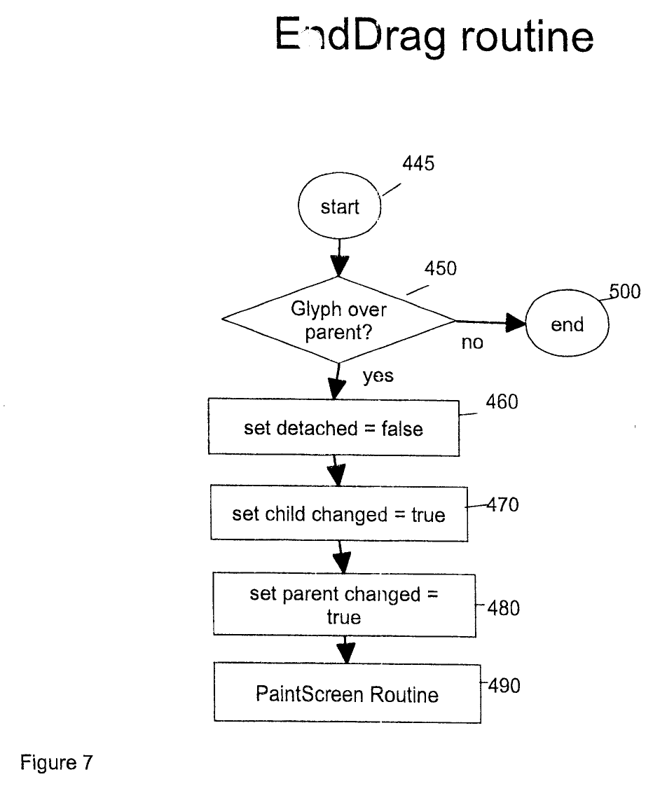

The system loops round until the outcome of this test is true, or another action is detected (not shown). If a drag is detected, then the process proceeds to step 210 and calls a StartDrag Routine (see FIG. 5). When this routine returns, the process proceeds to step 220 and continues to call the ContinueDrag Routine for as long as the system detects dragging occurring (220, 230) (see FIG. 6). When mouse drag is no longer detected (mouse button has been released), the EndDrag routine is called (step 240) (see FIG. 7).

With reference now to FIG. 5 and the StartDrag Routine, a drag has already been detected via the mouse handling routine (FIG. 4). Thus the process starts with step 300 which sets a ‘detached’ flag associated with the child glyph being moved to true (step 300). Therefore, as soon as a child glyph is moved it is assumed (for the time being) to be detached from its parent. At step 310 a second flag is set to indicate that this child glyph has changed in some way (e.g. its position). At step 320 a flag associated with that child's parent is set to indicate that the parent has also changed in some way. (Actually this process of setting changed flags ripples up the tree since if the representation of a child changes, then so will its parent, its grandparent, great-grandparent etc. It is only when a detached glyph is reached that the ripple effect halts. The ‘changed’ flags are used in a later routine to determine that an unattached glyph and its ultimate changed descendent (attached or unattached) will need to be recalculated (along with that child's ascendents). Also the change in its status may require a recalculation of the attached lines. Thus any future mention of the parent and child changed flags, should be taken to include the ripple effect.

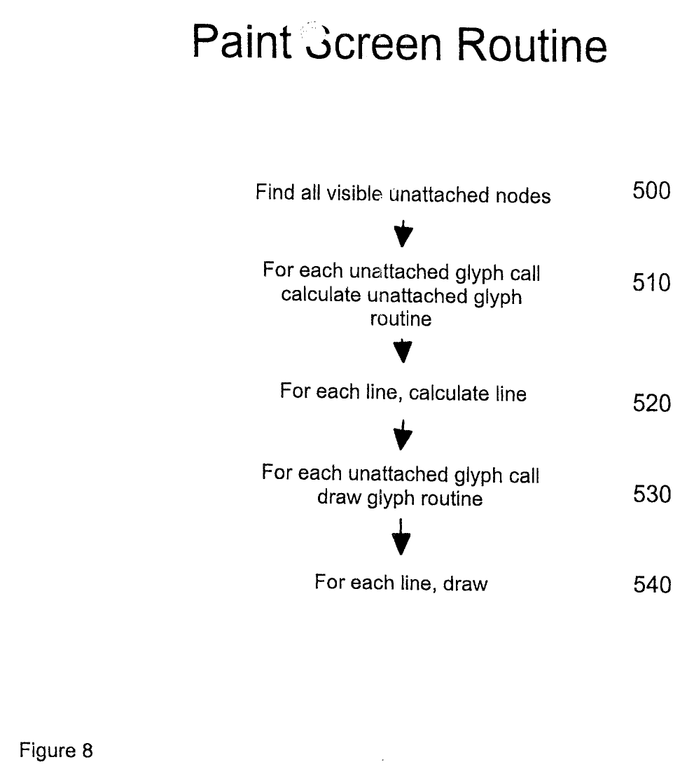

The screen position to which the glyph has moved is used to set the coordinates for the new screen position for that glyph (step 330) and the PaintScreen Routine (step 340) is called (see FIG. 8).

With reference to FIG. 6, as the user continues to drag the glyph, the display coordinates for that glyph are continually updated (step 400). The child changed and parent changed flags are repeatedly set to true (step 410) and the PaintScreen Routine called (step 420).

Finally the mouse handling routine (FIG. 4) detects at step 220 that mouse drag has ended and the EndDrag Routine is called. Therefore with reference to FIG. 7, a test is performed to determine whether the glyph is positioned (at least partly) over its parent (step 450). If it is not, then the process ends at step 500. This is because the setting of flags (i.e. the detached flag and parent/child changed flags); and the screen painting will already have been handled with respect to either the earlier StartDrag or ContinueDrag routines.

If the glyph is detected during the EndDrag routine as being positioned over its parent, then its detached flag is set to false (step 460). Its changed flag and its parent's changed flag are set to true (steps 470, 480). This is because the screen representation of both the parent and the child will have changed (i.e. moved position) as a result of reattachment and so their areas, line attachment points etc. will need to be recalculated (see later). The PaintScreen routine is then called (FIG. 8).

It will be appreciated from the above that as the selected glyph is dragged (i.e. its defining coordinates are continually updated), that glyph's descendents are also moved along with it (i.e. the descendents' coordinates are also updated). That is, unless a descendent is marked as detached, in which case it and its descendents are left alone. Thus once a glyph is found to be detached, that branch of the hierarchical structure is no longer traversed.

With reference now to FIG. 8, the PaintScreen routine will be explained. Recursive descent of the tree is performed to find unattached glyphs (this is determined by checking each glyph's detached flag) 500. In some embodiments, it is possible to declare at least some glyphs and any attached descendants as invisible. In this case an ‘invisible’ flag can be set to indicate when not to draw that glyph and any attached descendants. All lines to/from an invisible glyph will either disappear or be re-routed (e.g. to that glyph's logical parent). The detail regarding the painting of lines can be defined by the original programmer of the product, or tailored by the business user according to local needs (more on rules will be discussed below.) In such embodiments, it is also sensible to check whether a particular unattached glyph is visible. It is a waste of processing power to calculate those glyphs which are invisible and so will not be displayed to the user.

In an embodiment where glyphs cannot be declared as invisible, it may be assumed that each unattached glyph is visible.

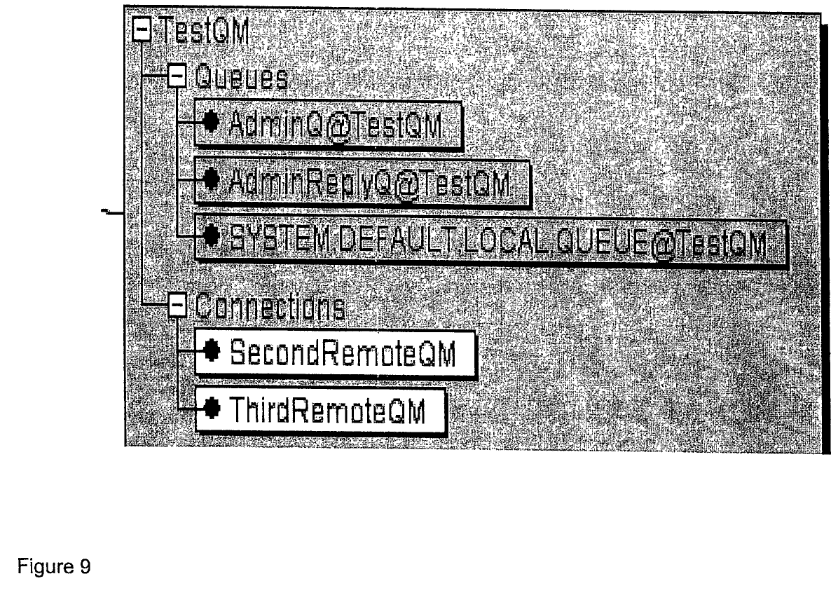

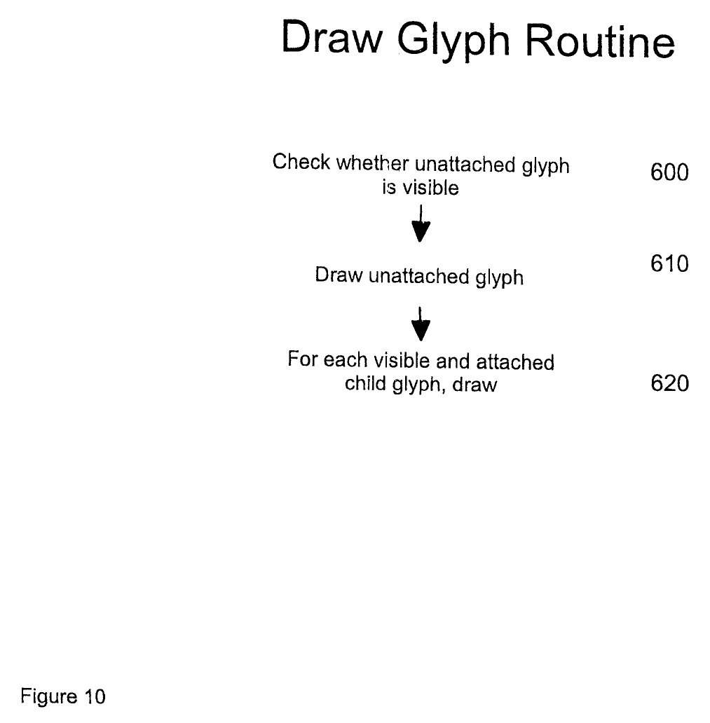

Glyphs meeting one or both criteria (according to the embodiment) are added to a list. In this way a set of starting points for the calculation/drawing routines is achieved. Each unattached glyph in the list is calculated by calling the calculate unattached glyph routine (explained with reference to FIG. 9). This routine calculates the size and position of the unattached glyph and its attached descendants (children, grandchildren etc.) 510. Subsequently, line positions are calculated 520 and then each unattached glyph (and attached visible descendants) are drawn by the draw glyph routine (see FIG. 10) 530 and the calculated lines are then drawn 540. Performing the glyph calculation routine first means that the size and positions of glyphs are known factors and therefore makes the calculation of lines a great deal simpler. Further, since lines are drawn across the top of glyphs, glyphs do not obscure lines causing possible loss of information. Of course line calculation will only be required where something has changed.

In the calculate unattached glyph routine each parent's size is calculated to be just big enough to contain its visible attached children. The location (xy position) of the unattached glyph's top lefthand corner is known (this is always the same unless a user drags the unattached glyph to a new position. In which case the new mouse coordinates will be recorded).

The amount of space needed to write the glyph's name (e.g. TestQM) is then calculated to define the initial width of the glyph and where a child glyph (if there is one and it is attached and visible) should be drawn on the screen (i.e. the xy coordinates of the lefthand corner of that child). The process loops round using the position of a previous glyph in the hierarchy to define where to draw the next glyph. Having dealt with all a parent's (attached) children, it is possible to calculate the size of that parent necessary to hold all of its children. It is then determined whether there are any other glyphs on the same level as that parent and these (and their children) can be calculated in the same way. Having calculated the size and position of all glyphs on the same level as described, it is then possible to calculate the size of the parent of those glyphs and so the process continues to loop round. Of course the routine is only ever called on an unattached glyph if that glyph is flagged as having changed (otherwise previously stored information can be used). Whenever a change occurs appropriate changed flags are set as mentioned above. Once a changed glyph has been calculated, its flag can be set to false.

In order to better understand this process, an example will be described with reference to unattached glyph TestQM as shown in FIG. 9. TestQM is the root of the unattached glyph. As previously mentioned, its lefthand corner of this glyph can be determined as can the amount of space (height and width) needed to display the name TestQM. The height needed to display the name is then used to determine where the first child of TestQM is to be displayed (i.e. Queues). The Queues glyph has children and so these must be calculated before the other child of TestQM (i.e. Connections). This is in order to determine where the last child of Queues is to be displayed such that the connections glyph can be displayed below it. Appropriate indentation of glyphs can also be factored in according to the level at which the glyph is located.

Thus having calculated all the children on the same level for Queues, the size of the Queues glyph can be calculated (i.e. it must be big enough to hold its four children). (In this example, the Queues glyph is not detachable and so it does not have a border/boundary.) Subsequently, the position of Connections can be calculated and since it has children, these must be calculated before the size of the Connections glyph itself is calculated. It will be appreciated from previous diagrams that the Connections glyph does have one detached glyph (FirstRemoteQM 61). This glyph is not calculated at this point because it will be dealt with later when that unattached glyph is retrieved from the list of unattached glyphs at another time. Since TestQM has only two children, its size may be calculated next such that it can accommodate its children.

Thus the tree is recursively descended, first calculating the position of each glyph and then the tree is ascended to calculate the necessary size of a glyph in order to accommodate any children.

It should be noted that a glyph and its children are only calculated if that glyph is visible. A glyph may not be visible because it has been classified as invisible (this can be determined by checking an ‘invisible flag’ associated with the glyph) or because its parent glyph is collapsed (this can be verified by checking an expanded flag associated with the glyph's parent. If this flag is set, then the glyph is visible. If on the other hand, this flag is not set then the glyph is not visible and so neither will its attached children be visible.)

Once each unattached glyph has been calculated by the routine described with reference to FIG. 9, the process returns to the PaintScreen routine and the lines are calculated. These are calculated in accordance with normal practice, with one exception. If a glyph is classed as detached (by checking the appropriate detached flag), then a special edge will eventually be drawn from that glyph to its logical parent. As mentioned above, lines are only recalculated if a source or destination glyph has changed, otherwise previously stored information regarding lines can be used.

Having calculated the lines the DrawUnattachedGlyph routine is called for each unattached glyph 530. This routine will now be discussed with reference to FIG. 10.

First it is verified whether an unattached glyph is visible 600 (unattached glyphs are retrieved from the list of such glyphs created during the PaintScreen routine). Assuming it is, then this glyph is drawn 610. A recursive descent of each visible unattached glyph and its associated glyphs is performed. This involves checking each associated glyph and its children (and their children etc.) to determine whether they are visible and attached. In one embodiment, this involves checking a flag indicating whether that glyph's parent is expanded to show its children (the expanded flag) to determine that a glyph is visible and the detached flag to check that the glyph is attached. Assuming that both tests are true, then the glyph in question is drawn 620. Of course in an embodiment where a glyph may be declared invisible, this flag should also be checked. It can be assumed that those attached glyphs which are not visible, will not have any visible children attached thereto.

Thus the means by which glyphs can be created and detached from/attached to their parents has been described.

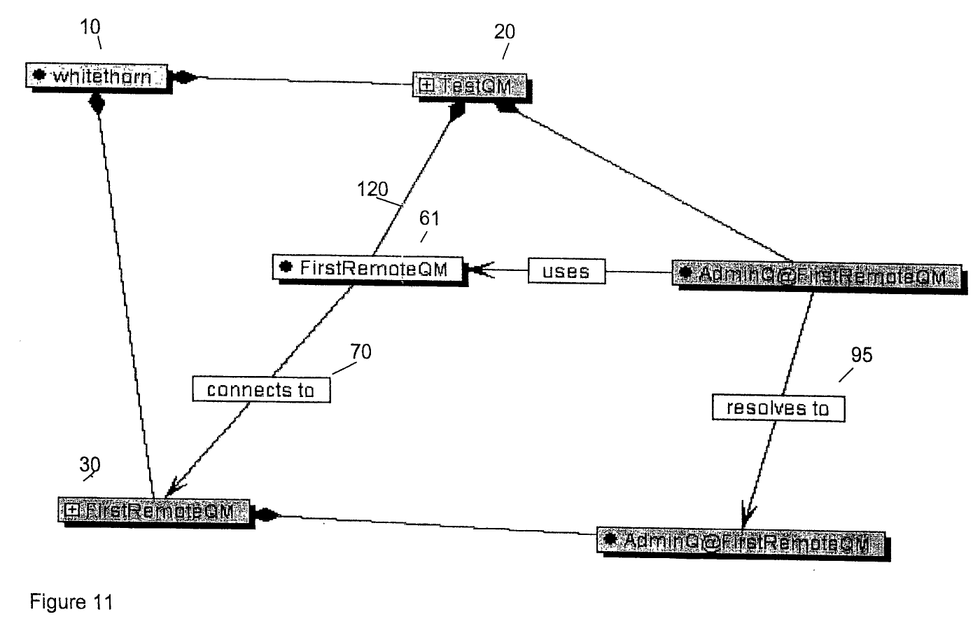

Of course the user may not actually be interested in, for example, all the detail of the two queue manager glyphs of FIG. 3. In which case such detail just clutters/wastes screen area. FIG. 11 shows how a user can simplify a diagram's complexity and thereby relinquish space for the display of additional information that is desired. In this example, this is achieved by collapsing both the TestQM 20 and the FirstRemoteQM glyph 30 to display the root node in each glyph's hierarchy.

The processing to achieve this involves collapsing all branches attached to the selected glyph and thereby removing any child glyphs attached thereto in the normal manner. The only difference being, each child glyph (be it a direct or indirect descendent of the selected glyph) is examined to determine whether the ‘detached’ flag associated therewith is set to indicate that the child glyph in question is separated from its parent which is being collapsed. (Note by collapsing for example the TestQM tree of FIG. 2, this will collapse the Queue tree automatically) Any children with the ‘detached’ flag set are left alone (i.e. they are not deleted from view) and any of their descendents are also ignored. Thus in FIG. 11, glyph 61 remains in view despite its parent having been collapsed.

Additionally, as mentioned above there is a flag which is associated with each glyph having children. When that glyph is collapsed, the flag (expanded flag) is cleared. This flag is used as described with reference to FIGS. 9 and 10 to determine whether a glyph is visible or not.

Of course, when a glyph is expanded out to display its children, the reverse occurs. Processing again happens in the normal manner, except that once again the detached flag associated with each child is inspected. Those children that are not classed detached from their parent being expanded are displayed in the usual manner. Those that are left alone. Naturally, the expanded flag is set.

In the embodiment where a glyph and its attached children may be classed as invisible, any children associated with that glyph (directly or otherwise) and having their detached flag set are preferably also made invisible. Otherwise a detached child by itself would exist on the display area out of context.

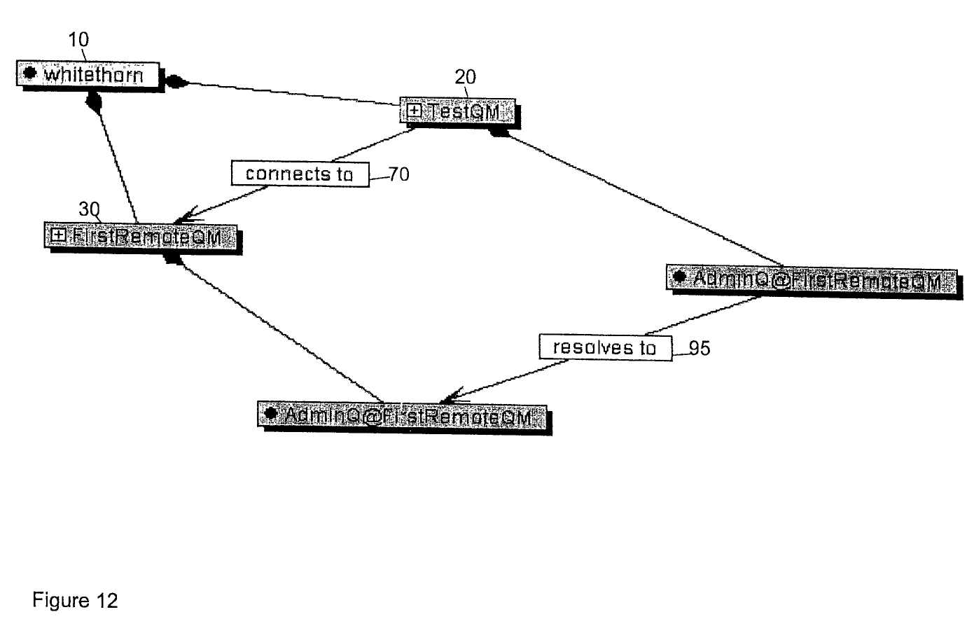

FIG. 12 shows how it is further possible to replace any unnecessary glyph back into its parent glyph, even if that parent glyph is not expanded to show its children. In this example the FirstRemoteQM connection glyph is no longer shown. The main processing for achieving this has already been described with reference to FIGS. 4 to 10. However an additional point to mention is that when a detached child is reattached to its parent the special edge (i.e. 120) linking that child to its parent is automatically deleted from display and the edge linking that child to its destination glyph is attached to the child's parent.

A number of rules such as this one are typically defined by the programmer of the original product. The preferred embodiment uses Object Orientated methods (OO) and therefore standard OO techniques can be employed to enable a customer (business user) to define additional business specific rules to modify the behaviour of glyphs. For example, the customer could change the fonts or colours used; define whether a glyph can change parents; define whether a glyph is allowed to be detached etc. Whether a particular rule is specified by the original programmer or the customer of the end product is an implementation detail, but the advantage of OO is that basic functionality can be extended as required. It will be seen from FIGS. 11 and 12 that when the FirstRemoteQM connection 61 is reunited with its parent glyph, the edge with the “uses” label is automatically removed. The rule for achieving this is “do not display if source or destination glyphs are attached”. This is one such rule which could be defined by the customer rather than the original programmer.

The customer is also able to define the types of glyphs that can be created by an end-user and what kind of children those glyphs should expect. Thus in the scenario described, the customer has defined the following types: “host”; “Queue Manager”; “Connections”; “Queues”. The customer has also defined that when, for example, a Queue Manager is created by the end-user, the glyphs “Connections” and “Queues” should be automatically created and that children of these types are expected. Further when a host is created, children of the type “Queue Manager” are to be expected.

Additional definitions can be associated with glyph types. For example that each queue will “use” a connection. Such that if an end-user detaches a queue and draws a line linking it to a connection, the annotation should be “uses” (see FIG. 3). In the same way, connections “connect to” glyphs. Such that when the FirstRemoteQM glyph 61 is detached and the user links it with the FirstRemoteQM queue manager, the “connects to” annotation is used. In this way lines can be automatically annotated based on pre-defined definitions. Definitions can also be associated with glyphs to define which other glyphs a particular glyph is permitted/or not permitted to link to. For example, perhaps connections can only be linked to queues.

In addition to the possibility of automatic annotation, it is also possible for edges/connectors to be automatically drawn. This is preferably achieved by the customer defining not only what children a particular type of glyph should expect, but also what form the name of those children should take. For example, the customer may define that the name of a queue should be of the form “queue identifier@queue manager name”. So with reference to FIG. 3, there is AdminQ@FirstRemoteQM 41. The form of the Connections glyphs may be that a connection will always take the name of the queue manager to which it connects (e.g. FirstRemoteQM 61) A link is then defined between queues and connections (i.e. that queues “use” connections—see above). Further it is defined that a queue uses a connection which has the same name as the second part of its name (i.e. after the @ symbol); and that in order for a line to be drawn between such a queue and connection, both must be detached from the same parent. So in FIG. 3, glyph 41 is detached, as is glyph 61. Further, the second part of glyph 41 name is identical to the name of glyph 61. Thus the rules define that a connection should be drawn between the two glyphs and that this may be (but does not have to be) annotated with the label “uses”.

Thus it is possible to tailor the screen display directly to the needs of the user. Unnecessary information can be removed/hidden from view, thereby leaving plenty of room for more useful information and the drag and drop interface of the preferred implementation also allows the user to arrange the glyphs as desired. For example, glyphs may be decreased in size and moved closer together in order to save screen real-estate.

Further there is only one representation of any entity which means that actions such as arrangement and navigation are performed on the same glyph. Screen space is not wasted due to a tree entity which is used purely for navigation. Trees are decomposable. Any child object may be separated from its owning tree. Finally, the separation of glyphs from their parents permits relationships in addition to a hierarchical one to be illustrated.

Additional enhancements to the embodiments described above will now be discussed. When a user reattaches a glyph to its parent, an indication that the detached child is hovering over its logical parent may be displayed (e.g. the logical parent and its attached descendants could be displayed as raised).

In one embodiment, the type associated with each glyph is displayed to the end-user. For example whitethorn 10 is a “host” with a “queue manager” TestQM 20 running on it. Of course if the type is also to be displayed (perhaps in a type bar above the glyph's name) then this has to be factored in to the calculate unattached glyph routine.

A further enhancement is to have a status bar across the bottom of the screen which is continually updated according to where a user's mouse cursor is hovering. So that when the user is over, for example, FirstRemoteQM 61, the status bar displays “Connection FirstRemoteQM, running on Queue Manager TestQM running on Host Whitethorn”. This is information is provided by the type associated with a glyph; its name; and defined links between glyph types (e.g. that connections “run” on queue managers). Such a status bar makes it much easier for a user to determine a glyph's parent, grand-parent, great-grandparent etc. This clears any confusion that might occur when, for example, a glyph is detached from its parent.

What is claimed is:

1. An apparatus for providing a GUI representation of relationships between a set of resources of a data processing system, including:
means for identifying a plurality of separable subsets each comprising one or more resources of the set of resources, wherein at least one of said subsets comprises an hierarchically ordered plurality of resources;
means for representing said separable subsets as interconnected elements within a single GUI representation of the set of resources, wherein the interconnections between elements represent relationships between the subsets of resources, and wherein an element corresponding to an hierarchically ordered plurality of resources includes a representation of the hierarchical order; and
means, responsive to user interaction with one or more of said elements of the GUI representation, for repositioning said one or more elements independently of the positioning of other elements of said GUI representation, and updating the representation of interconnections between the elements in response to said repositioning to retain within the single GUI representation a representation of the relationships between the repositioned elements.

2. The apparatus of claim 1 comprising:
means, responsive to user interaction, for collapsing an element to a graphical node representation without collapsing other elements.

3. The apparatus of claim 1 comprising:
means, responsive to user interaction, for collapsing a hierarchically ordered resource, represented as part of an element, to hide any descendents also represented as part of the element, wherein said collapsing is performed without collapsing any part of another element.

4. The apparatus of claim 1 comprising:
means for extracting a subset of one or more resources from an existing hierarchically represented subset to create an element.

5. The apparatus of claim 4, wherein the extracting means comprises:
means for accessing first information stored regarding which resources are to be extracted as part of a subset, and second information for retaining a representation of relationships between the resources in such a subset, within the GUI representation, when the element is created.

6. The apparatus of claim 4 comprising:
means for reattaching an extracted subset to the hierarchically represented subset from which it was extracted.

7. The apparatus of claim 6 comprising:
means for determining whether a part of the hierarchy to which the extracted subset is reattached, is collapsed; and
means responsive to determining that the part is not collapsed for representing the reattached subset in its current form.

8. The apparatus of claim 7, wherein the part to which the extracted subset is reattached is collapsed, and the representation means does not display the reattached subset.

9. The apparatus of claim 1 comprising:
means for resizing an element to take account of a change made an element.

10. The apparatus of claim 1 comprising:
means for defining at least one rule regarding the behaviour of a resource.

11. The apparatus of claim 1 comprising:
means for defining at least one rule regarding the display of a relationship between two elements.

12. The apparatus of claim 11 comprising:
means for associating a definition with at least some resources;
means for determining that a relationship should be displayed between two elements, each element comprising at least one hierarchically ordered resource, wherein said determining is based on the definition associated with the root resource of each element.

13. The apparatus of claim 11 comprising:
means for annotating a relationship between two elements, each element comprising at least one hierarchically ordered resource, said annotation being based upon a definition associated with the root resource of each element.

14. The apparatus of claim 1 comprising:
means for displaying the hierarchical relationship between a resource and its ascendants.

15. The apparatus of claim 1 comprising:
means for classifying an element or part thereof as invisible, such that it is not displayed, independently of other elements.

16. A method for providing a GUI representation of relationships between a set of resources of a data processing system, including:
identifying a plurality of separable subsets each comprising one or more resources of the set of resources, wherein at least one of said subsets comprises an hierarchically ordered plurality of resources;
representing said separable subsets as interconnected elements within a single GUI representation of the set of resources, wherein the interconnections between elements represent relationships between the subsets of resources, and wherein an element corresponding to an hierarchically ordered plurality of resources includes a representation of the hierarchical order; and
responsive to user interaction with one or more of said elements of the GUI representation, repositioning said one or more elements independently of the positioning of other elements of said GUI representation, and updating the representation of interconnections between the elements in response to said repositioning to retain within the single GUI representation a representation of the relationships between the repositioned elements.

17. The method of claim 16 comprising the steps of:
responsive to user interaction, collapsing an element to a graphical node representation without collapsing other elements.

18. The method of claim 16 comprising:
responsive to user interaction, collapsing a hierarchically ordered resource, represented as part of an element, to hide any descendents also represented as part of the element, wherein said collapsing is performed without collapsing any part of another element.

19. The method of claim 16 comprising:
extracting a subset of one or more resources from an existing hierarchically represented subset to create an element.

20. The method of claim 19, wherein the extracting step comprises:
accessing first information stored regarding which resources are to be extracted as part of a subset, and second information for retaining a representation of relationships between the resources in such a subset, within the GUI representation, when the element is created.

21. The method of claim 19 comprising:
reattaching an extracted subset to the hierarchically represented subset from which it was extracted.

22. The method of claim 21 comprising:
determining whether a part of the hierarchy to which the extracted subset is reattached, is collapsed; and
responsive to determining that the part is not collapsed, representing the reattached subset in its current form.

23. The method of claim 22, wherein the part to which the extracted subset is reattached is collapsed, and the reattached subset is not represented.

24. The method of claim 16 comprising:
resizing an element to take account of a change made an element.

25. The method of claim 16 comprising:
defining at least one rule regarding the behaviour of a resource.

26. The method of claim 16 comprising:
defining at least one rule regarding the display of a relationship between two elements.

27. The method of claim 26 comprising:
associating a definition with at least some resources;
determining that a relationship should be displayed between two elements, each element comprising at least one hierarchically ordered resource, wherein said determining is based on the definition associated with the root resource of each element.

28. The method of claim 26 comprising:
annotating a relationship between two elements, each element comprising at least one hierarchically ordered resource, said annotation being based upon a definition associated with the root resource of each element.

29. The method of claim 16 comprising:
classifying an element or part thereof as invisible, such that it is not displayed, independently of other elements.

30. The method of claim 16 comprising:
displaying the hierarchical relationship between a resource and its ascendants.

31. A computer program for providing a GUI representation of relationships between a set of resources of a data processing system, said program comprising program code means adapted to perform the following steps:
identifying a plurality of separable subsets each comprising one or more resources of the set of resources, wherein at least one of said subsets comprises an hierarchically ordered plurality of resources;
representing said separable subsets as interconnected elements within a single GUI representation of the set of resources, wherein the interconnections between elements represent relationships between the subsets of resources, and wherein an element corresponding to an hierarchically ordered plurality of resources includes a representation of the hierarchical order; and
responsive to user interaction with one or more of said elements of the GUI representation, repositioning said one or more elements independently of the positioning of other elements of said GUI representation, and updating the representation of interconnections between the elements in response to said repositioning to retain within the single GUI representation a representation of the relationships between the repositioned elements.
